(19) United States
(12) Patent Application Publication
(10) Pub. No.: US 2016/0138279 A1
(43) Pub. Date: May 19, 2016

(54) TILE ASSEMBLING APPARATUS

(71) Applicant: NWG TOOLS OY, Oulu (FI)

(72) Inventor: Sami JUSSINNIEMI, Oulu (FI)

(73) Assignee: NWG TOOLS OY, Oulu (FI)

(21) Appl. No.: 14/902,364

(22) PCT Filed: Jul. 4, 2013
(86) PCT No.: PCT/FI2013/050734

§ 371 Date: Dec. 31, 2015

(51) Int. Cl. E04F 21/18; E04F 21/20; B28D 7/00

(52) U.S. Cl. CPC E04F 21/1883; B28D 7/005; E04F 21/20

(57) ABSTRACT

There is provided a tile assembling apparatus (300) for forming a layer (106) of a plurality of tiles, comprising: a tile rack (302) for storing a plurality of tiles; a tile assembly area (304) on which the layer (106) of the plurality of tiles is to be formed; a tile moving equipment (306) configured to repeatedly fetch available tiles (310) from the tile rack (302) and move the fetched tiles (310) along a transport line (400) from the tile rack (302) towards the tile assembly area (304); and a spacer feeding equipment (314) dis-posed between the tile rack (302) and the tile assembly area (304), wherein the spacer feeding equipment (314) is configured to feed a spacer (316) behind or in front of the tile (310) on the transport line (400) in order to separate adjacent tiles from each other in a first direction with the spacer (316).

### FIELD

The invention relates generally to an apparatus for assembling a group of tiles in a layer such that the layer of tiles is then ready to be moved to a floor or a wall of a worksite.

### BACKGROUND

A tile 100 of FIG. 1 is a manufactured piece of hard-wearing material such as ceramic, stone, metal, or even glass. Tiles are generally used to form wall and floor coverings, and may range from simple square tiles to complex mosaics.

Typically a person tiling a wall (i.e. covering the surface of the wall with tiles), performs the tiling manually one-by-one, by first placing one tile against the wall, then another next to the previous one, etc. When one row of tiles 102A is ready in the wall, the person may stretch a spacer string or ribbon 104 above the row of tiles 102A, in order to make sure that the next row 102B of tiles is separated from the already laid row of tiles 102A. The horizontal separation may be obtained by using the spacer ribbon 104 in the vertical direction. At the end, the wall may be covered with a layer 106 of tiles. In FIG. 1, the layer 106 comprises six tiles 100. This is both time consuming and hard work.

### BRIEF DESCRIPTION OF THE INVENTION

According to an aspect of the invention, there are provided apparatuses as specified in claims 1, 16 and 18.

According to an aspect of the invention, there is provided a method program product as specified in claim 14.

According to an aspect of the invention, there is provided a computer program product as specified in claim 15.

According to an aspect of the invention, there is provided a computer-readable distribution medium carrying the above-mentioned computer program product.

According to an aspect of the invention, there is provided an apparatus comprising means for performing any of the embodiments as described in the appended claims.

Embodiments of the invention are defined in the dependent claims.

### LIST OF DRAWINGS

In the following, the invention will be described in greater detail with reference to the embodiments and the accompanying drawings, in which

FIG. 1 presents a layer of tiles, according to an embodiment;

FIG. 2 shows controlling unit of a tile assembling apparatus, according to an embodiment;

FIG. 3 shows the tile assembling apparatus, according to an embodiment;

FIG. 4 illustrates movement of a tile along a transport line, according to an embodiment

FIG. 5A and 5B depict some embodiments related to a spacer feeding equipment;

FIG. 6 illustrates a measuring unit, according to an embodiment;

FIGS. 7A and 7B illustrate the spacer, according to some embodiments;

FIGS. 8A and 8B illustrate the spacer and a wireless receiver, according to some embodiments;

FIG. 9 illustrates a portable gripping apparatus, according to an embodiment; and

FIGS. 10A and 10B illustrate a replaceable sealing member, according to an embodiment.

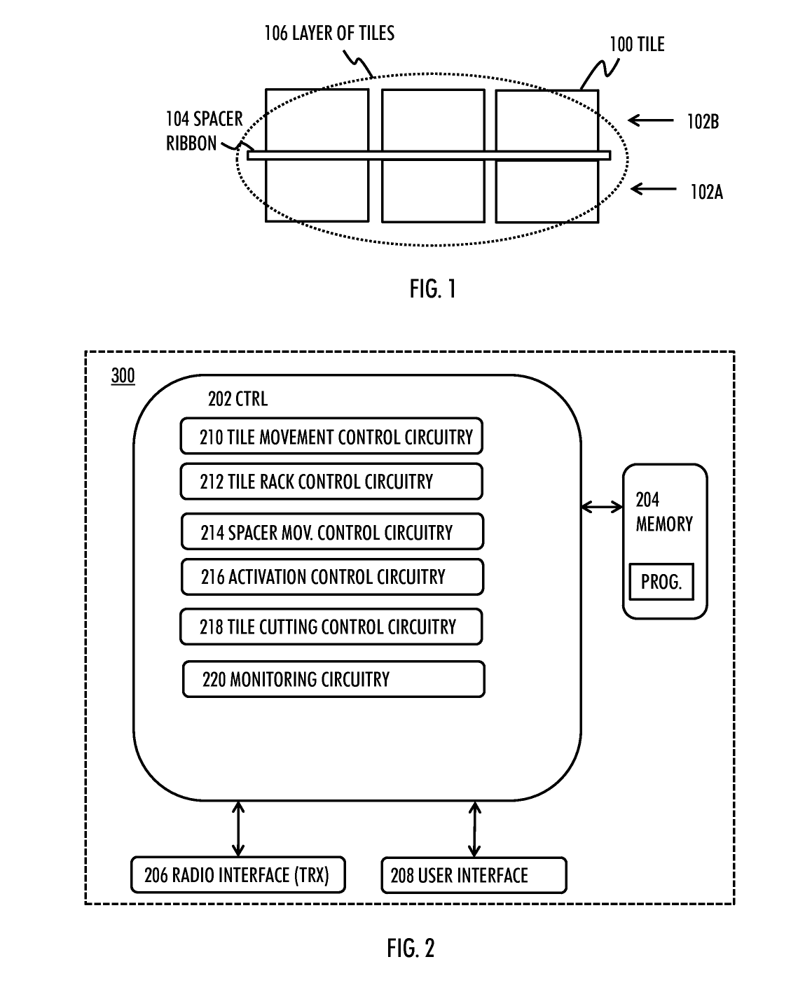

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

As indicated earlier, the current manner of tiling tiles 100 in order to cover the surface of a floor or a wall is not efficient. As an alternative, in prior art, layers of tiles may have been pre-formed at a tile factory and possibly tied together by applying, for example, a net or alike on the back side of the layer. However, this does not provide flexibility in terms of the requirements of the worksite. Further, such pre-formed layers are difficult to handle and they require a lot of space for storing, etc.

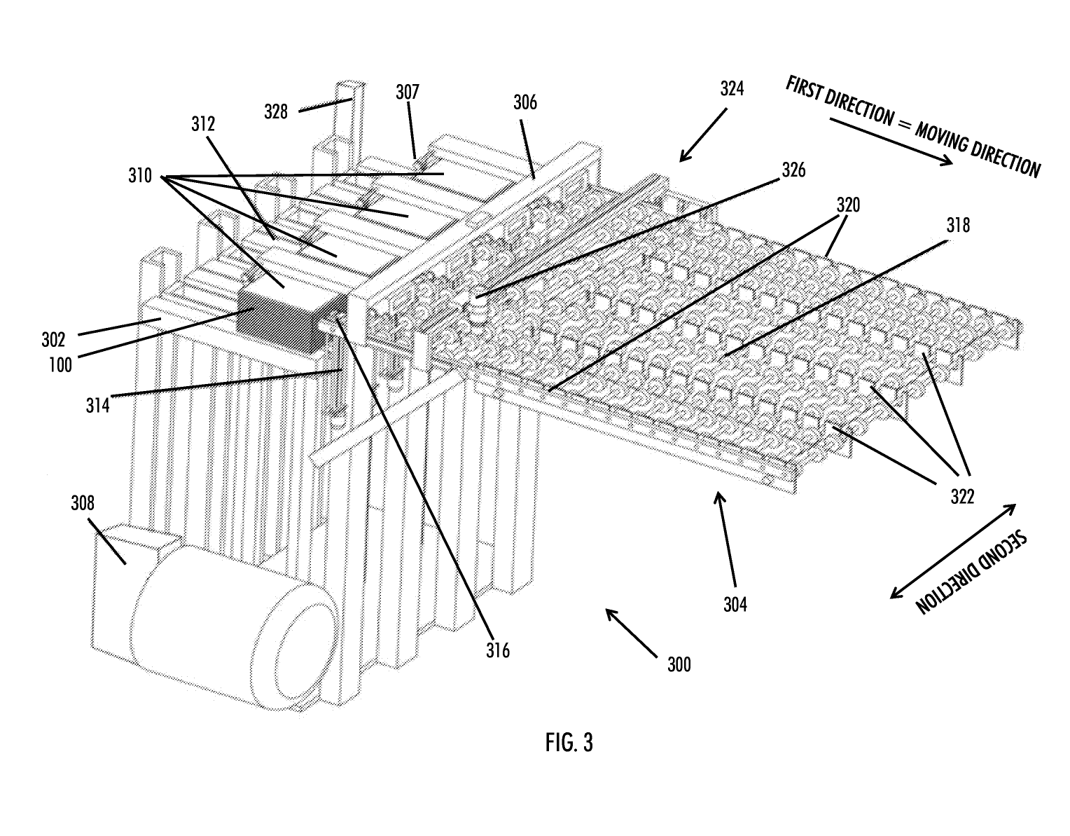

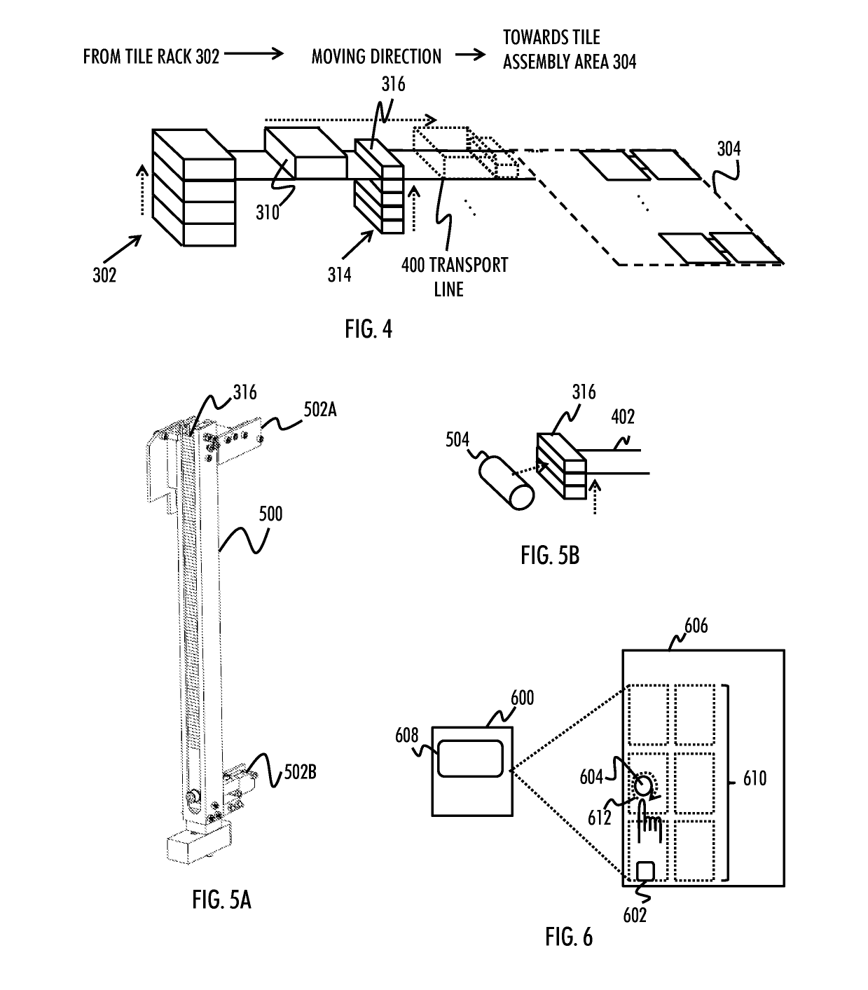

Therefore, as shown in FIGS. 3 and 4, there is provided an apparatus 300 for forming a layer 106 of a plurality of tiles 100, wherein the layer 106 is formed in the same form as it will be on the to-be-covered surface. In other words, the layer 106 may be readily picked up from the apparatus 300 and placed to the surface which is to be tiled. Advantageously, the apparatus 300 may be used directly in the workplace, e.g. in a bathroom, kitchen, or any place in which the tiling is performed. In an embodiment, the apparatus 300 is portable so that it may be carried to the working place. Thus, the layer 106 of tiles may be advantageously formed in the worksite according to the requirements set by, e.g., the physical dimensions of the wall, locations of electric socket outlets, etc. Therefore, the proposed apparatus 300 provides a worksite specific manner of generating a layer 106 of tiles to be used on the to-be-covered surface. In an embodiment, the apparatus is a worksite apparatus. The apparatus 300 may be called a tile assembling apparatus. The use of such apparatus 300 may significantly reduce the time needed for coating the surface, ensure that the tile separation is equal between each pair of tiles (aesthetic effect), and reduce the risk of the tiling person damaging him-/herself, for example.

With respect to FIGS. 3 and 4, the apparatus 300 comprises a tile rack 302 for storing a plurality of tiles 100 and a tile assembly area 304 on which the layer 106 of the plurality of tiles is to be formed. The apparatus 300 further comprises a tile moving equipment 306 configured to repeatedly fetch available tiles 310 from the tile rack 302 and move the fetched tiles 310 along a transport line 400 from the tile rack 302 towards the tile assembly area 304. Thus, in an embodiment, the tile moving equipment 306 may fetch, for example, the uppermost tile(s) from the tile rack 302 and transport it/them in a moving direction along the transport line 400 towards the tile assembly area 304. It should be noted that the transport line 400 need not be a straight line but it may comprise angles both in vertical and horizontal directions. However, in one embodiment, the transport line 400 is a straight line from the tile rack 302 towards the tile assembly area 304.

The tile moving equipment 306 may be configured to perform the movement of the tiles 100 along the transport line 400 with at least one of the following: low-pressure, gripping fingers 307. For example, the tile moving equipment 306 may grip a back edge of each available tile 310 on the tile rack 302 with gripping fingers 307 (as shown in FIG. 3), or grip the surface of each available tile 310 on the tile rack 302 by applying low-pressure. In order to provide the low pressure, the apparatus 300 may comprise a low-pressure generation unit 308, such as a high-power vacuum. For the sake of clarity, FIG. 4 does not show the tile moving equipment 306. In some other embodiments, the gripping fingers grip the sides of the tile 310 by pressing the tile 310 between the gripping fingers. In one embodiment, the tile moving equipment 306 may also comprise hooks for gripping the bottom surface of the tile 100.

The tile moving equipment 306 may be mounted on a mechanism which enables the movement along the transport line 400. Such mechanism may comprise rails along which the tile moving equipment 306 may move. There may further be a mechanism for enabling the movement of the tile moving equipment 306, such as a gearwheel and a step-motor, or alike. By actuating the gearwheel back and forth with the motor, the repeating movement of the tile moving equipment 306 may be provided. In some other embodiments, the movement may be performed with hydraulics or pressurized air, for example. As shown in FIG. 2, the apparatus 300 may further comprise a control circuitry (CTRL) 202, such as at least one processor, and at least one memory 204 including a computer program code (PROG), wherein the at least one memory 204 and the computer program code (PROG), are configured, with the at least one processor 202, to cause the apparatus 300 to control the repeating movement of the tile moving equipment 306. This may be accomplished with a tile movement control circuitry 210.

In an embodiment, the tile rack 302 is configured to move the stored plurality of tiles 100 in response to the tile moving equipment 306 fetching the currently available tiles 310 from the tile rack, in order to provide the tile moving equipment 306 with the next available tiles from the tile rack 302. As indicated earlier, the currently available tiles 310 may, in an embodiment, correspond to the uppermost tiles in the tile rack 302. However, it may also be that the tile rack 302 does not store the tiles in a vertical pile (although so shown in FIGS. 3 and 4), but the tile rack 302 is to be understood broadly to cover any shelve or area reserved for the tiles 100.

For example, in an embodiment, the tile rack 302 comprises a plurality of adjacent tile stands 312, each tile stand 312 being configured to move the tiles 100 in the tile stand 312 in response to the tile moving equipment 306 moving the currently available tile 310 from the tile stand 312.

In another embodiment, the tile rack 302 stores the tiles 100 in a format of a horizontal row of tiles. In such case, the gripping fingers may grip the available tile 310 on the side edges by pressing the tile 310 between the fingers, or low pressure effect may be applied on the surface of the available tile 310. Thereafter, the fetched tile 310 may be turned into the level corresponding to the orientation of the transport line 400 (such as to a horizontal level) and moved along the transport line 400.

The tile rack 302 may be made out of metal (e.g. aluminum), plastic, wood or other suitable material. In an embodiment, the storage area size of the tile rack 302 (or each tile stand 312) is adjustable according to the size of the to-be-applied tile 100. Such adjustment may be performed with adjustable frame surrounding the storage area of the tiles 100. The walls of the frame may be movable, for example, and fastened with screws or alike.

As said, the tile rack 302 may further comprise a mechanism for moving the plurality of tiles 100 in response to the tile moving equipment 306 fetching the currently available tiles 310 from the tile rack 302, in order to provide the tile moving equipment 306 with the next available tiles from the tile rack 302. In an embodiment, the movement of tiles in the tile rack 302 may be arranged with at least one of the following: a step motor, a spring, the gravity. Thus, in an embodiment, there is a step motor moving the tiles in the tile rack 302, e.g. upwards stepwise each time the tile moving equipment 306 fetches a tile 310 from the tile rack 302 so as to provide another tile to be fetched. The step motor may be powered by electricity, hydraulics, fuel, etc. The step motor may be configured, with a tile rack control circuitry 212 of FIG. 2, to move the tiles 100 in the tile rack only a predetermined amount. This amount may correspond to the thickness of one tile. There may further be sensors, such as a light sensor, machine vision sensor, pressure sensor, etc., which monitor the movement of the tiles 100 in the tile rack 302. The sensors may output information to the circuitry 212 which may then control the movement of the tiles in the tile rack 302. In case of a spring causing the movement of the tiles, there may be a stopper for controlling the amount of movement, such as a hook, a lip, or another protruding part in the tile rack 302 which allows only one tile to pass in each tile stand 312, for example. In case of gravity moving the tiles, there may be stopper which allows only one tile to drop or slide to the location from which the tile moving equipment 306 fetches the tile.

The tile rack 302 may, in an embodiment, comprise a leveling tool for equal leveling of all of the available tiles 310 in the tile rack (e.g. in the tile stands 312). The leveling tool may comprise a sensor spring (pressure sensors) underneath each pile of tiles which output information to the circuitry 212 for ensuring that the available tiles 310 of the piles are at the same level. Similarly, machine vision may be applied for performing such leveling.

In another embodiment, the tile moving equipment 306 is configured to fetch the available tile 310 from the tile rack 302 without the tiles in the tile rack 302 moving. Thus, the tile moving equipment 306 may, in the embodiments of FIGS. 3 and 4, move also vertically in order to fetch the uppermost tile 310 from the tile rack 302. It may be noted that in case there are a plurality of tiles in the tile rack 302, the last tile to be fetched from the bottom of the tile rack/stand 302/312 may require the tile moving equipment 306 to move significantly in the vertical direction.

As shown in FIGS. 3 and 4, the apparatus 300 may further comprise a spacer feeding equipment 314 disposed between the tile rack 302 and the tile assembly area 304, wherein the spacer feeding equipment 314 is configured to feed a spacer 316 behind or in front of the tile 310 on the transport line 400 in order to separate adjacent tiles from each other in a first direction with the spacer 316. In an embodiment, the spacer 316 is fed in front of the tile 310 so that the tile 310 becomes physically contacted with the spacer 316 while the tile 310 moves along the transport line 400, as shown in FIG. 4. In an embodiment, the tile 310 on the transport line 400 is constantly moving by the tile moving equipment 306. In an embodiment, it may be so that the spacer 316 is not fed for the first moving tile.

In an embodiment, the tile 310 on the transport line 400 is temporarily stopped and the spacer 316 is attached to the stopped tile 310 by the spacer feeding equipment 314. In an embodiment, the spacer feeding equipment 314 comprises a spacer moving mechanism for moving the spacer 316 to the stopped tile 310 on the transport line. The spacer moving mechanism may comprise gripping units for gripping the spacer 316 and a robot arm for moving the gripped spacer 316 to be attached in front or behind (backside) of the stopped tile 310.

In an embodiment, the spacer feeding equipment 314 is further configured to feed a feed a spacer on a side of the tile 310 on the transport line 400 in order to separate adjacent tiles from each other in a second direction which is orthogonal to the first direction. For example, the spacer feeding equipment 314 may comprise a spacer moving mechanism with gripping units for gripping the spacer and moving (e.g. with a robot arm) the gripped spacer to be attached on the side of the tile 310. The tile 310 may or may not be stopped during the attachment. As will be described later, the spacer may attach to the front/back/side of the tile 310 with glue or a sticker, for example.

FIG. 5A shows a more detailed illustration of the spacer feeding equipment 314. As shown the spacer feeding equipment 314 comprises a spacer rack 500 for storing a plurality of spacers, wherein the spacer rack 500 is configured to move the plurality of spacers in response to the moving tile 310 fetching the currently available spacer 316 from the spacer rack 500, in order to feed the next available spacer from the spacer rack 500 for the next moving tile. For example, looking at FIG. 4, in an embodiment, the spacer rack 500 is configured to stepwise move upwards each time a moving tile 310 picks up a currently available spacer 316.

The equipment 314 may be made of metal, plastic, wood or another appropriate material. FIG. 5A shows also attaching units 502A, 502B for attaching the spacer rack 500 to the frame of the apparatus 300. The spacer rack 500 may comprise a support frame for tightly holding the plurality of spacers, out of which the uppermost may in an embodiment be the currently available spacer 316. The support frame may be arranged to be adjusted according to the size of the spacers applied. Such adjustment may be achieved with movable walls, for example. The support frame may, in an embodiment, be a hollow metal pipe or tube in which the spacers are placed in a pile.

As was the case with the tile rack 302, also the movement of the spacers in the spacer rack 500 is, in an embodiment, arranged with at least one of the following: a step motor, a spring, the gravity. Thus, what is said in connection of the movement of the tiles in the tile rack 302 may also be applied for the movement of the spacers. For example, the spacers may be allowed to move only a predetermined amount, such as an amount corresponding to the thickness of the spacer 316. In order to perform such controlled movement, there may be a spacer feeding equipment control circuitry 214 and/or stoppers. In addition, similar sensors as may be applied for controlling the movement of the tiles in the tile rack 302 may be applied also for controlling the movement of the spacers in the spacer rack 500.

In an embodiment, the spacer 316 is configured to adhere to the moving tile 310 with an adhesive. The adhesive may a sticker or glue (e.g. fast glue, heat sensitive glue), silicon, tape, or any adhering material. The spacer feeding equipment 314 may comprise an activation unit 504 (shown in FIG. 5B). The activation unit 504 may be configured to activate the adhesive for adhering to the moving tile 310. In an embodiment, the activation is performed for the spacer 316 at the location from which the moving tile 310 is to fetch the spacer 316. In another embodiment, the activation is performed for the spacer 316 while the spacer rack 500 moves the spacer 316 to the location from which the moving tile 310 is to fetch the spacer 316. In an embodiment, the activation is performed for the spacer which going to be the next available spacer 316. E.g. this may denote activating the second uppermost spacer in FIG. 5B.

In an embodiment, the activation is performed with at least one of the following: heating the adhesive on the spacer 316, removing a coating from the adhesive on the spacer 316, coating the spacer 316 with the adhesive, exposing the adhesive on the spacer 316 with an activation agent. For example, the spacer 316 may comprise heat sensitive adhesive. In such case, heating the spacer 316 may activate the adhesive so that the tile 310 touching the spacer 316 substantially immediately adheres to the moving tile 310. Similarly, an agent may be spread on the already existing adhesive on the spacer 316 so that the agent activates the adhesive. In an embodiment, the activation unit 504 may spread an adhesive to the spacer 316 in case the spacer 316 does not already comprise the adhesive on its surface. For these the activation unit 504 may comprise nozzles or brushes, pressurized container, heating equipment, etc. Further, the heating, or the spread of an agent or the adhesive may be controlled by an activation control circuitry 216. In one embodiment, the adhesive on the spacer 316 may be covered with a coating, such as plastic tape. In such case, the activation unit 504 may remove the coating. Such activation unit 504 may be a lip which removes the coating as the spacer 316 move upwards, for example. Alternatively, the activation unit 504 may be configured to move as controlled by the activation control circuitry 216 so that the movement of the activation unit 504 performs the removing of the coating. These embodiments for activating the adhesive just before the adhesion is needed may provide for ease of storage of the spacers, as the stored spacers do not yet comprise activated adhesive on their surface. Further, the embodiment in which the adhesion is added only in the apparatus 300 may provide for ease of manufacture of the spacers.

In an embodiment, the transport line 400, on which the tiles 310 are moved, comprises wheels 318 on which the tiles 310 are configured to be moved. Such use of wheels 318 may provide for ease of movement of the tiles 310 and cheap production costs compared to, e.g. a belt conveyer (which may alternatively be implemented on the transport line 400 for providing the movement of the tiles 310 on the transport line 400). Wheels 318 may be present also on the tile assembly area 304, as shown in FIG. 3. The wheels may be made of plastic or metal, for example.

In an embodiment, the tile assembly area 304 may comprise an end wall configured to stop the movement of the tiles in the first direction any further, side walls 320 configured to position the layer 106 on the tile assembly area, and at least one separating member 322 configured to separate adjacent tiles from each other in a second direction, which is orthogonal to the first direction. This is made in order to form the layer 106 of tiles on the assembly area 304, wherein the layer 106 comprises a desired amount of tiles which are separated from each other with the spacers 316 in the first direction and with the separating members 322 in the second direction. Thus, the layer 106 may be ready to be lifted to the wall or floor which is to be tiled without further adjustments with respect to the positions of the tiles in the layer 106.

In an embodiment, the side walls 320 and/or the at least one separating member 322 is movable in the second direction. This may be advantageous as then the plurality of tiles may arrive to the assembly area 304 loosely and the side walls 320 may be used to push the tiles against each other in the second direction so that the separating members 322 are first arranged between the tiles which are adjacent to each other in the second direction. The separating members 322 may be continuous or non-continuous walls protruding upwards from the surface of the assembly area 304 between the adjacent tiles, or the separating members 322 may comprise elements, such as pins, which protrude upwards between each pair of tiles, for example.

In an embodiment, the separating members 322 are replaceable so that the seam (space) between adjacent tiles may be selected according to current needs. Alternatively, the thickness of the separating members 322, such as walls, may be configurable. For example, each separating member 322 may comprise two walls and the separation between the walls may be changed by moving the walls to or from each other. For example, the smallest separation may be acquired once the two walls are side-by-side (against each other). The movement of the separating walls 322 may be obtained with rails underneath the assembly area 304 and an electric motor, for example. In one other embodiment, the tiles in the layer 106 are positioned with respect to the second direction by applying gripping fingers or low pressure gripping elements, such as suction pads, for example. In such case, the correct separation between adjacent tiles may be obtained with machine vision sensors, laser sensors, etc.

It should be noted that there may be more than one transport lines 400 in the apparatus 300, as shown in FIG. 3 and in FIG. 4 with triple dots. As a result, the layer 106 of tiles which is formed in the tile assembly area 304 may be large and comprise rows and columns of tiles (matrix of tiles), as shown in FIG. 4.

In an embodiment, the apparatus 300 may comprise a tile cutting area 324 disposed before the tile assembly area 304, wherein the tile moving equipment 306 is configured to move the tiles to the tile cutting area 324. Thus, the layer 106 of the plurality of tiles may be first formed on the tile cutting area 324 before the layer 106 is transported further to the tile assembly area 304. The tile cutting area 324, as well as the tile assembly area 304, may comprise wheels 318 and may be made of metal, plastic or wood, for example. In an embodiment, however, the two areas 304 and 324 are substantially the same area.

A tile cutting equipment 326 may be configured to cut the layer 106 of tiles on the tile cutting area 324 on the basis of computer instructions. Thus the cutting is performed automatically without the person needing to apply saws or other tools for the cutting. This may significantly reduce the risk of injury. The cutting may comprise cutting the tiles, making holes to the tiles, or generally removing parts of the tiles. The reason for making such cutting may be due to the to-be-coated surface having electric sockets, lamp switches, small dimensions (e.g. when tiling edges of the room), etc.

The tile cutting equipment 326 may work in a three-dimensional coordinate space (XYZ axes) at least above the tile cutting area 324. The tile cutting equipment 326 may further be configured to move along rails in the three dimensional space. The tile cutting equipment 326 may comprise gripping fingers and coupling for gripping and coupling required tool for the cutting, including diamond blades, drill bits, water pressure tools, etc. In an embodiment, the tile cutting equipment 326 may fetch the required tool from a tool storage unit. In an embodiment, the tile cutting equipment 326 comprises a swivel robot arm for enabling fast and accurate movement and cutting.

The tile cutting equipment 326 may further comprise a layer gripping equipment configured to hold the layer 106 of tiles during the cutting. This may be achieved by low pressure gripping pads touching the surface of the tiles, or gripping units which may press the tiles softly against the tile cutting area 324, for example. After the cutting is performed, the layer gripping equipment (or the tile moving equipment 306) may move the tooled layer 106 to the tile assembly area 304.

In an embodiment, there may be positioning means for positioning the layer 106 on the area 324 as desired. The positioning means may comprise movable side and/or end walls, or gripping units (finger or low pressure suction pads), for example. This may be important so that it is known that the layer 106 is in the correct position while the cutting is done. The accurate positioning may be achieved with sensors, such as machine vision sensors, laser sensors, cameras, etc.

In an embodiment, there are provided removing means for removing dust and dirt from the surface of the layers 106 after the cutting. The means may comprise, for example, a low pressure suction unit generating a suction effect on the surface of the layer 106 which sucks the dirt and dust out of the surface of the layer 106. Another embodiment may apply blowing means for blowing the dust away from the surface of the layer 106.

In an embodiment, the location which is to be removed by the tile cutting element 326 is measured manually from the surface which is to be coated (floor, wall), and the measured data is fed/inputted to a tile cutting control circuitry 218 which may control the tile cutting equipment 326. Thus, the cutting itself may be automated operation on the basis of computer instructions from the circuitry 218. The circuitry 218 may also control the movement of the layer gripping equipment, the positioning means, and the removing means.

In an embodiment, as shown in FIG. 6 there is a measuring unit 600 for measuring the locations of the electric sockets 602, lamp switches 604, etc. on the to-be-coated surface 606. Similarly, it may be that the layer 106 of tiles is too wide/tall to fit onto the surface. In such cases the measuring unit 600 may be used to measure the required width/height of the layer 106. The measuring unit 600 may transmit the measured data (e.g. distance of the electric socket 602 from the wall/ceiling and from the edge of the wall) to the circuitry 218 of the apparatus 300. The transmission may be wireless (WiFi, cellular data network, Bluetooth, etc.). The circuitry 218 may then map the received data into XY coordinates on the surface of the layer 106 and apply the tile cutting equipment 326 to tool the 106 layer accordingly. Once the circuitry 218 receives the data, the cutting of the layer 106 at the correct locations may be performed automatically. In one embodiment, though, the user may fine tune the inputted cutting parameters and finally accept/approve the location which is to be cut with a user interface 208.

The measuring unit 600 may thus comprise at least a transmitter (which may be a wireless transmitter), distance measuring tools (e.g. measuring tape, laser distance measuring tool, and a memory for storing the measured data for transmission. The measuring unit 600 may be coupled to or comprised in the apparatus 300. The measuring unit may further comprise a display 608 for displaying the measured information, a user interface for inputting user commands to the measuring unit.

In an embodiment, the measuring unit 600 may be configured to display a view of the formed layer 106 on the display 608 so that the user may manually input the locations to be cut on the display 608 of the measuring unit 600. The input may be via a touch display or buttons, for example. In order to show the layer 106 to the user, the measuring unit may receive information from the apparatus 300 regarding the size and form of the assembled layer 106 of tiles.

In yet one embodiment, the measuring unit 600 may project a view of the formed layer 106 of tiles onto the surface 606 which is to be coated/tiled, e.g. project the layer 106 to the wall in real size). The projection is marked with reference numeral 610 in FIG. 6. Then the user may, by hand gestures 612 or motion sensor, for example, determine the locations which are to be removed from the layer 106. For example, the user may circle the electric socket 602 on the wall with a hand gesture 612 or with a sensor, or the user may point the location of the lamp switch 604, for example. Movement/pointing coordinates of the hand 612 or the sensor is recorded by the measuring unit by means of a machine vision, a camera, a motion sensor data receiver, for example. and transmitted to the tile assembly apparatus 300 and, more particularly, to the circuitry 218. This may provide a reliable manner of determining the parts of the layer 106 which are to be removed by the tile cutting equipment 326.

In an embodiment, the tile assembling apparatus 300 comprises a monitoring circuitry 220 configured to determine at least one of the following: the number of tiles in each layer 106, a surface area covered with each layer 106, the total number of tiles in a plurality of layers, total surface area covered with the plurality of layers, a surface area of removed parts of tiles, number of spacers 316 applied. Such information may be measured with machine vision by monitoring layers 106 assembled on the tile assembly area 304, by receiving information obtained from any of the circuitries 210-218. Further, the size of each tile may be predetermined and inputted to the controller 202. The monitoring circuitry 220, together with the memory 204, may then store the determined information to the memory 204.

A radio interface 206, comprising hardware and/or software for realizing communication connectivity according to one or more communication protocols, may then transmit the stored information to a network. The transmission may take place wirelessly via WiFi, Bluetooth, cellular data network, for example. The receiver in the network may be, e.g., a tiling company's database so that the amount of tiles used, time spent, etc. may be obtained for the purposes of invoicing the client, for example. In another embodiment, the receiver in the network may be the tiling person's electronic work diary, a mobile phone application, etc.

The apparatus 300 may also comprise a user interface 208 comprising, for example, at least one keypad, a microphone, a touch display, a display, a speaker, etc. The user interface 208 may be used to control the apparatus 300 by the user, to input data to any of the circuitries 210-220, for example.

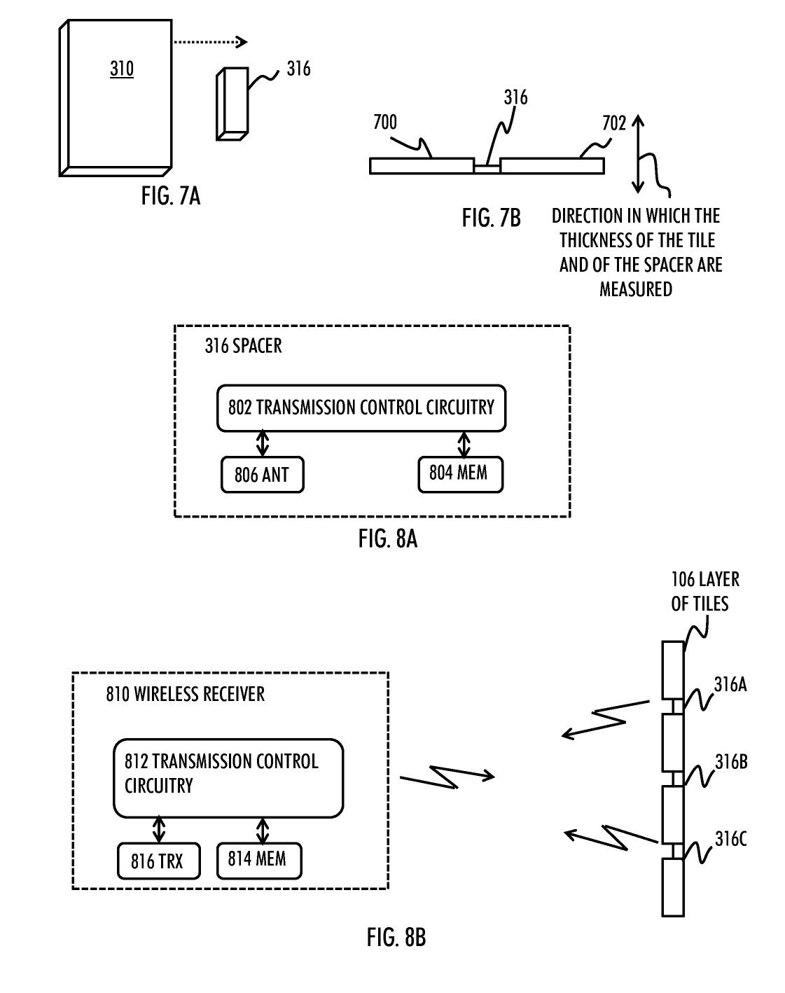

An embodiment of the spacer is shown in more details in FIGS. 7A and 7B. The spacer 316 is used for separating adjacent tiles 700, 702 from each other. The material of the spacer 316 may be made of, e.g., metal, plastic, silicon, glue, rubber, etc. The form of the spacer element/member 316 may be a pin, a square, an ellipse, a rectangle, a circle. The form and dimensions of the spacer 316 may be selected according to current needs and the selected type of spacers may be then added to the spacer rack 500.

In an embodiment, the width of the spacer 316 (i.e. the separation between adjacent tiles 700, 702) may be between 0.1-25 millimeters. In an embodiment, as shown in FIG. 7B, the thickness of the spacer 316 is smaller than the thickness of the tile 310, 700, 702, thereby ensuring that once the generated layer 106 of tiles is on the to-be-covered surface, the spacer 316 is not visible through a seaming material. The seaming material may be mortal or plaster, for example, and it is used to cover the spaces between the tiles 700, 702.

In an embodiment, the spacer 316, which is configured to be left behind a seam material on the coated surface, comprises a wireless antenna configured to transmit specific information wirelessly in order to indicate the presence of the spacer 316 to a wireless receiver. This is shown in FIGS. 8A and 8B in which the spacer 316 is shown to comprise a transmission control circuitry 802, a memory 804 for storing to-be-transmitted information, and the antenna 806. The antenna may be made of printed electronics, for example. As shown in FIG. 8B, the wireless receiver 810 may comprise functional entities, such as a transmission control circuitry 812, a memory 814 for storing to-be-transmitted received, and a transceiver 816 for receiving the information from the spacers 316A to 316C (commonly denoted with reference numeral 316 in this example). The wireless receiver 810 may also comprise a user interface, e.g., a display from which the user of the receiver 810 may observe whether or not any spacers 316A to 316C are found.

The wireless transmission may apply WiFi, Bluetooth, cellular communication protocols, for example. The information transmitted to the receiver 810 from the spacer 316 may comprise identification of the specific spacer 316, or data identifying the general type of the spacer 316, for example.

In an embodiment, the wireless antenna 806 is a passive antenna transmitting information only in response to receiving a radio frequency signal providing energy for the wireless transmission. Thus, the antenna 806 of the spacer 316 may emit an identifier data as a response to receiving a radio frequency signal. Such solution may apply, e.g. a passive radio frequency identification (RFID)-technique. In another embodiment, the spacer 316 comprises a battery or another source of energy for providing active type of data transmission. In one embodiment, only some of the applied spacers of a layer 106 comprise the wireless antenna. As shown in FIG. 8B, only spacers 316A and 316C transmit the identification data. Thus, in an embodiment, each layer 106 may be arranged to comprise at least one spacer 316 which provides the wireless transmission of the identifier.

In one embodiment, the spacer comprising the wireless antenna is arranged on a netlike structure attached on the backside of the layer of tiles 106. The netlike structure may comprise many spacers. In one embodiment, the spacer is attached with a tape on the backside of the layer 106.

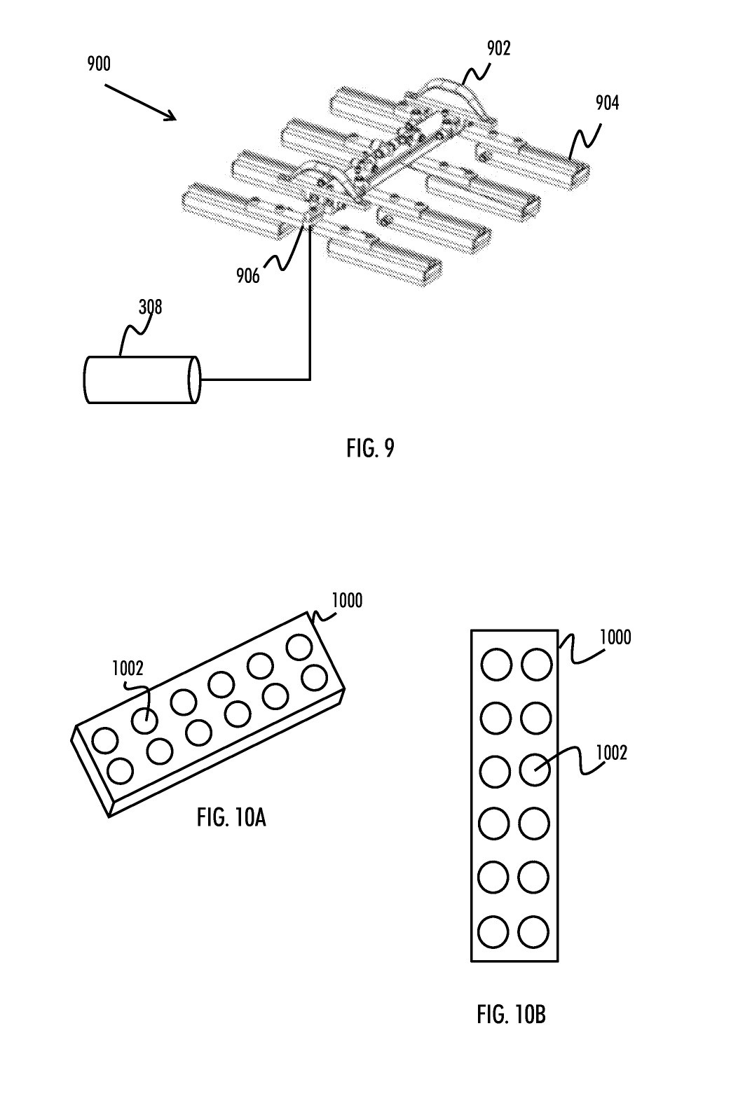

There is also provided a portable gripping apparatus 900, as shown in FIG. 9. The gripping apparatus 900 may be configured to grip the formed tile layer 106. The frame of the portable gripping apparatus 900 may be made of aluminum, metal, plastic, wood, etc. The portable gripping apparatus 900 may comprise handles 902 for moving the portable gripping apparatus 900 manually. The portable gripping apparatus 900 may further comprise at least one gripping member 904 configured to be set against the tile layer 106. In the apparatus 900 of FIG. 9, there are eight gripping members 904, each of which may grip to one or more tiles in the layer 106. The gripping members 904 may be movable and fastenable to desired positions. The gripping members 904 may be so arranged that each of the tiles in the layer 106 is gripped. This may ensure that the assembled layer 106 may be picked from the tile assembly area 304 without the separations between the tiles changing. Thus, no mutual movement of the tiles takes place, but the complete layer 106 is moved as one element. The portable gripping apparatus 900 may be used to move the layer 106 to the wall or floor, or any surface which is to be coated.

The person making the movement may first dip the layer 106 into a container of mortar or plaster (or any attachment material) used for providing attachment of the layer 106 of tiles to the wall, for example. The container of the attachment material may comprise a mechanism for preventing an excessive amount of the attachment material from being in contact with the layer 106. For example, the mechanism may include stoppers which prevent the upper surface of the layer 106 to be exposed to the attachment material. As one example, the depth of the container may stop the upper side of the layer 106 from being exposed to the attaching material and only allow the bottom side of the layer 106 to touch the attachment material. In one embodiment, there may be a base against which the layer 106 is pressed with the portable gripping apparatus 900. The base may then be lowered a predetermined amount or the base may comprise apertures through which a predetermined amount of the attaching material is fed to the bottom side of the layer 106.

As shown, the portable gripping apparatus 900 may comprise a coupling 906 configured to couple the portable gripping apparatus 900 with the low-pressure unit 308 in order to enable a grip a surface of the tile layer 106 by applying low-pressure. An air channel, such as a hose or tube, may be attached to the coupling 906, wherein the air-channel provides for the suction effect from the low-pressure unit 308. The gripping apparatus 900 may also comprise buttons for triggering the low-pressure effect on and off.

The portable gripping apparatus 900 may further comprise a replaceable sealing member 1000, as shown in FIGS. 10A and 10B. FIG. 10A shows a diagonal view of the member 1000, whereas FIG. 10B shows a top view of the member 1000. The replaceable sealing member 1000 may be disposed between the surface of the tile layer 106 and the at least one gripping member 904, wherein the replaceable sealing member 1000 is configured to seal the interface between the at least one gripping member 904 and the surface of the tile layer 106 air-tightly. The replaceable sealing member 1000 may comprise several apertures 1002 for providing and guiding the low-pressure suction effect against the surface of the tile layer 106. Similarly, a plurality of apertures may be present in the corresponding locations in the gripping members 904. In FIGS. 10A and 10B, the member 1000 is shown to have 12 apertures 1002. The member 1000 may be attached to each gripping member 904.

It may be important to be able to replace the sealing member 100 as the current sealing member 100 may be exposed to dust and dirt in the workplace environment. Therefore, instead of cleaning the sealing member 1000, it may be advantageous to replace the sealing member 1000. The sealing member 1000 may be made of rubber, such as a cellular rubber or a foam rubber, for example. The attachment and/or detachment of the sealing member 1000 may be achieved with a tape, glue, for example.

In an embodiment, there is provided a tile rack in which the tiles are assembled manually or with a help of moving walls in a desired form, such as into three-by-three layers of tiles. The moving walls may be used also to separate the tiles from each other with a separation which corresponds substantially to the physical dimension of the spacer 316. Such desired layers may be piled on the tile rack. Thereafter, the portable gripping apparatus 900 may be used to lift the uppermost layer of tiles from the tile rack, and carry the layer to the surface which is to be coated. In this embodiment, the portable gripping apparatus 900 may further comprise an equipment to feed the spacers between the adjacent tiles of the layer so as to provide for the tile separation also on the wall after the portable gripping apparatus 900 releases the grip of the layer. In such embodiment, there may not be any need for the transport line 400, for example.

The number and form of the plurality of tiles in the layer 106 may be predetermined and inputted via the user interface to the tile assembling apparatus 300. In one embodiment, the layer 106 may comprise 12 tiles, e.g., three rows of four tiles or four rows of three tiles. The apparatus 300 may be retriggered to form another layer 106 of tiles according to user needs by inputting commands via the user interface 208, for example. Each layer 106 of tiles may be specifically designed according to current needs. For example, the person may first form a layer 106 which covers most of the wall, attach the formed layer 106 onto the wall, and then make another, different sized layer of tiles in order to cover the rest of the wall. Depending on the dimensions of the rest of the wall, it may be that the tile cutting equipment 326 needs to cut the layer of tiles before attaching the second layer to the wall.

The tile assembly apparatus 300 may comprise a guiding unit 328 for guiding the placement of the formed layer 106 to the floor or to the wall (or to any surface which is to be covered). The guiding unit 328 may comprise, e.g. a ray of light (e.g. a laser ray) which projects a horizontal and/or vertical line to the surface which is to be covered. This may ensure that the person tiling the surface places the layer 106 of tiles horizontally and/or vertically correctly on the surface.

According to an aspect, there is provided a tile assembling apparatus for forming a layer of a plurality of tiles, wherein the layer is formed in the same form as it will be on the to-be-covered surface, the tile assembling apparatus comprising: a tile storing means for storing a plurality of tiles; a tile assembly area on which the layer of the plurality of tiles is to be formed; a tile moving means for repeatedly fetching available tiles from the tile storing means and moving the fetched tiles along transport means from the tile storing means towards the tile assembly area; and a spacer feeding means disposed between the tile storing means and the tile assembly area, wherein the spacer feeding means are for feeding a spacer behind or in front of the tile on the transport means in order to separate adjacent tiles from each other in a first direction with the spacer. The apparatus may also comprise tile cutting means for cutting the layer of tiles according to computer instructions.

According to an aspect, there is provided a method for forming a layer of a plurality of tiles, wherein the layer is formed in the same form as it will be on the to-be-covered surface, the method comprising: repeatedly fetching, by a tile moving equipment, available tiles from a tile rack and moving the fetched tiles along a transport line from the tile rack towards a tile assembly area on which the layer of the plurality of tiles is to be formed; and feeding, by a spacer feeding equipment, a spacer behind or in front of the tile on the transport line in order to separate adjacent tiles from each other in a first direction with the spacer, wherein the spacer feeding equipment is disposed between the tile rack and the tile assembly area.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A tile assembling apparatus for forming a layer of a plurality of tiles, wherein the layer is formed in the same form as it will be on the to-be-covered surface, and the layer comprises a plurality of rows and a plurality of columns of tiles, the tile assembling apparatus comprising:
at least two tile racks, each for storing a plurality of tiles;
a tile assembly area on which the layer of the plurality of tiles is to be formed;
at least two transport lines, one for each tile rack, along which tiles move from the tile racks to the tile assembly area, wherein the ends of the transport lines are comprised in the tile assembly area;
a tile moving equipment configured to repeatedly fetch available tiles from the tile racks and to cause the movement of the fetched tiles along the transport lines from the tile racks towards the tile assembly area; and
a spacer feeding equipment disposed between the tile rack racks and the tile assembly area wherein the spacer feeding equipment is configured to feed a spacer on the transport line behind or in front of the tile moving on each transport line, such that the moving tile fetches the fed spacer, in order to separate adjacent tiles in the formed layer of tiles from each other in a first direction with the spacer, wherein the first direction is the movement direction of the tiles, and
at least one separating member configured to separate adjacent tiles in the formed layer of tiles from each other in a second direction, which is orthogonal to the first direction.

2. The tile assembling apparatus of claim 1, wherein the tile moving equipment is configured to perform the movement of the tiles along the transport lines with at least one of the following: low-pressure, gripping fingers.

3. The tile assembling apparatus of claim 1, wherein each tile rack is configured to move the plurality of tiles in response to the tile moving equipment fetching the currently available tiles from the tile racks, in order to provide the tile moving equipment with the next available tiles from the tile racks.

4. The tile assembling apparatus of claim 1, wherein the spacer feeding equipment comprises at least two spacer racks, each for storing a plurality of spacers, wherein each spacer rack is configured to move the plurality of spacers in response to the moving tile fetching the currently available spacer from the spacer rack, in order to feed the next available spacer from the spacer rack for the next moving tile.

5. The tile assembling apparatus of claim 3, wherein the movement of the tiles and/or spacers in the tile racks and/or in the spacer racks is arranged with at least one of the following: a step motor, a spring, the gravity.

6. The tile assembling apparatus of claim 1, wherein the spacer is configured to adhere to the moving tile with an adhesive, and wherein the spacer feeding equipment comprises an activation unit configured to activate the adhesive for adhering to the moving tile.

7. The tile assembling apparatus of claim 6, wherein the activation is performed with at least one of the following: heating the adhesive on the spacer, removing a coating from the adhesive on the spacer coating the spacer with the adhesive, exposing the adhesive on the spacer with an activation agent.

8. The tile assembling apparatus of claim 1, wherein the tile moving equipment is configured to repeatedly move back and forth, thereby pushing the adjacent tiles forward in the first direction towards the tile assembly area on the transport line, and wherein the transport lines, along which the tiles are being pushed, comprises wheels.

9. The tile assembling apparatus of claim 1, wherein the tile assembly area comprises:
an end wall configured to stop the movement of the tiles; and side walls configured to position the layer on the tile assembly area.

10. The tile assembling apparatus of claim 9, wherein the side walls and/or the at least one separating member is movable in the second direction.

11. The tile assembling apparatus of claim 1, wherein the tile assembling apparatus further comprises:
a tile cutting area disposed before the tile assembly area, wherein the tile moving equipment is configured to move the tiles to the tile cutting area, thereby forming the layer of the plurality of tiles on the tile cutting area; and
a tile cutting equipment configured to cut the layer of tiles on the tile cutting area on the basis of computer instructions.

12. The tile assembling apparatus of claim 11, wherein the tile cutting equipment comprises a layer gripping equipment configured to:
hold the layer of tiles during the cutting; and
move the layer to the tile assembly area after the cutting.

13. The tile assembling apparatus of claim 1, wherein the tile assembling apparatus further comprises:
at least one processor and at least one memory including a computer program code, wherein the at least one memory and the computer program code are configured, with the at least one processor, to cause the apparatus to:
determine at least one of the following: the number of tiles in each layer, a surface area covered with each layer the total number of tiles in a plurality of layers, total surface area covered with the plurality of layers, a surface area of removed parts of tiles, number of spacers applied;
store the determined information to the memory; and
transmit the stored information to a network.

14. A method for forming a layer of a plurality of tiles, wherein the layer is formed in the same form as it will be on the to-be-covered surface and the layer comprises a plurality of rows and a plurality of columns of tiles, the method comprising:
repeatedly fetching, by a tile moving equipment, available tiles from at least two tile racks, each for storing a plurality of tiles, and causing a movement of the fetched tiles along corresponding transport line lines from the tile racks towards a tile assembly area on which the layer of the plurality of tiles is to be formed, wherein the ends of the transport lines are comprised in the tile assembly area; and
feeding, by a spacer feeding equipment a spacer on the transport line behind or in front of the tile moving on each transport line, such that the moving tile fetches the fed spacer, in order to separate adjacent tiles in the formed layer of tiles from each other in a first direction with the spacer, wherein the first direction is the movement direction of the tiles, wherein the spacer feeding equipment is disposed between the tile rack racks and the tile assembly area,
separating adjacent tiles in the formed layer of tiles from each other in a second direction by at least one separating member, the second direction being orthogonal to the first direction.

15. A computer program product embodied on a distribution medium readable by a computer and comprising program instructions which, when loaded into an apparatus, execute the method according to claim 14.

16.-19. (canceled)
